(19) United States
(12) Patent Application Publication
(10) Pub. No.: US 2008/0282050 A1
(43) Pub. Date: Nov. 13, 2008

(54) Methods and arrangements for controlling memory operations

(75) Inventor: Karl-Heinz Grabner, Pfeifersiedlung (AT)

Correspondence Address: Alan Carlson, 6202 Lynn Lane, Lago Vista, TX, 78645, US

(73) Assignee: ON Demand Microelectronics

(21) Appl. No.: 11/800,990

(22) Filed: May 7, 2007

(51) Int. Cl. G06F 12/00

(52) U.S. Cl. 711/169

(57) ABSTRACT

In one embodiment, a method for operating a memory management system concurrently with a processing pipeline is disclosed. The memory management system can fetch and effectively load registers to reduce stalling of the pipeline because the disclosed system provides improved data retrieval as compared to traditional systems. The method can include storing a memory request limit parameter, receiving a memory retrieval request from a multi-processor system to retrieve contents of a memory location and to place the contents in a predetermined location. The method can also include determining a number of pending memory retrieval requests, and then processing a new retrieval request if the number of pending memory retrieval requests is at or below the memory request limit parameter.

### FIELD OF THE DISCLOSURE

This disclosure relates to memory function to support parallel processing units and to methods and arrangements for controlling memory functions that support the parallel processor architecture.

### BACKGROUND OF THE INVENTION

Typical instruction processing pipelines in modern processor architectures have several stages that include a fetch stage, a decode stage and an execute stage. The fetch stage can load memory contents, possibly instructions and/or data, useable by the processors. The decode stage can get the proper instructions and data to the appropriate locations and the execute stage can execute the instructions. Concurrently, data required by the execute stage can be passed along with the instructions in the pipeline. In some configurations, data can be stored in a separate memory system such that there are two separate memory retrieval systems, one for instructions and one for memory. In a system that utilizes very long instruction words the decode stage can expand and split the instructions, assigning portions or segments of the total instruction word to individual processing units and can pass instruction segments to the execution stage.

One advantage of instruction pipelines is that the complex process can be broken up into stages where each stage specialized in a function and each stage can execute a process relatively independently of the other stages. For example, one stage may access instruction memories, one stage may access data memories, one stage may decode instructions, one stage may expand of instructions and a stage near the execution stage may analyze whether data is scheduled or timed appropriately and sent the correct register. Each of these processed can be done concurrently or in parallel. Further, another stage may write the results of the execution back to memories or to register files. Thus, all of the abovementioned stages can operate concurrently.

Accordingly, each stage can perform a task, concurrently with the processor/execution stage. Pipeline processing can enable a system to process a sequence of instructions, one instruction per stage concurrently to improve processing power due to the concurrent operation of all stages. In a pipeline environment, in one clock cycle one instruction or one segment of data can be fetched by the memory system, whilst another instruction is decoded in the decode stage, whilst another instruction is be executed in the execute stage.

In a non-pipeline environment, one instruction can require numerous clock cycles to be executed/processed (i.e. one clock cycle for each retrieve/fetch, decode and execute). However, in a pipeline configuration while an instruction is being processed by one stage, others stages can be concurrently retrieving, decoding and processing data. This is particularly important because a pipeline system can fetch or “pre-fetch” data from a memory location that takes a long time to retrieve such that the data is available at the appropriate time so that the pipeline does not have to stall and wait for this “long lead time” data. However, traditional data retrieval systems do not efficiently load processors of a pipeline creating considerable stalling as the execute stage waits for the required data.

### SUMMARY OF THE INVENTION

In one embodiment, a method for operating a memory management system concurrently with a processing pipeline is disclosed. The memory management system can fetch and effectively load registers to reduce stalling of the pipeline because the disclosed system provides improved data retrieval as compared to traditional systems. The method can include storing a memory request limit parameter, receiving a memory retrieval request from a multi-processor system to retrieve contents of a memory location and to place the contents in a predetermined location. The method can also include determining a number of pending memory retrieval requests, and then processing a new retrieval request if the number of pending memory retrieval requests is at or below the memory request limit parameter.

To determine the number of pending memory retrieval requests, the system can count a number of requests sent to a memory management system by incrementing the count when a request is sent to the memory management system and decrementing the count when a request has been processed by at least a portion of the memory management system.

In another embodiment, an apparatus for managing memory is disclosed. The apparatus can include a memory management module to retrieve data from a memory in response to a retrieval request from a multi-processor system. The memory management module can process a plurality of retrieval requests at any given time and can process a plurality of retrieval requests concurrently for multiple processors operating in a pipeline configuration. The apparatus can also include a memory retrieval request controller to monitor the plurality of retrieval requests in process within the memory management module and to prevent, at least partially, execution of a retrieval request by the memory management module in response to the plurality of pending retrieval requests being greater than a predetermine processing limit.

### BRIEF DESCRIPTION OF THE DRAWINGS

In the following the disclosure is explained in further detail with the use of preferred embodiments, which shall not limit the scope of the invention.

FIG. 1 shows a block diagram of a data memory subsystem control module;

FIG. 2 is a block diagram of a processor architecture having parallel processing modules;

FIG. 3 is a block diagram of a processor core having a parallel processing architecture;

FIG. 4 is an instruction processing pipeline using a data memory subsystem (DMS) control module;

FIG. 5 shows an embodiment 500 of a DMS control module 463 using a tag stack and arrays to store the load request information;

FIG. 6 is a block diagram of a write-back module consisting of a write-back control module 670 and a destination data alignment module 680;

FIG. 7 is a flow diagram of a method for issuing asynchronous memory load requests;

FIG. 8 is a flow diagram of a method for asynchronously reading memory data;

FIG. 9 is a flow diagram of a method for accessing data of a register for which an asynchronous memory load request has been issued;

FIG. 10 shows a load request in a simple example code snippet; and

FIG. 11 shows a load request in a simple example code snippet where the register R1 is overwritten.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatus and arrangements for issuing asynchronous memory load requests in a multi-unit processor pipeline that can execute very long instruction words (VLIW)s is disclosed. The pipeline can have a plurality of processing units, a register module, and a variety of internal and external memories. In one embodiment, methods, apparatus, and arrangements for controlling a memory retrieval work load for asynchronous memory requests is disclosed. In another embodiment, methods, apparatus and arrangements for anticipating what data will be needed to supply the pipeline is disclosed, where when the data is not needed it can be purged from the memory retrieval system.

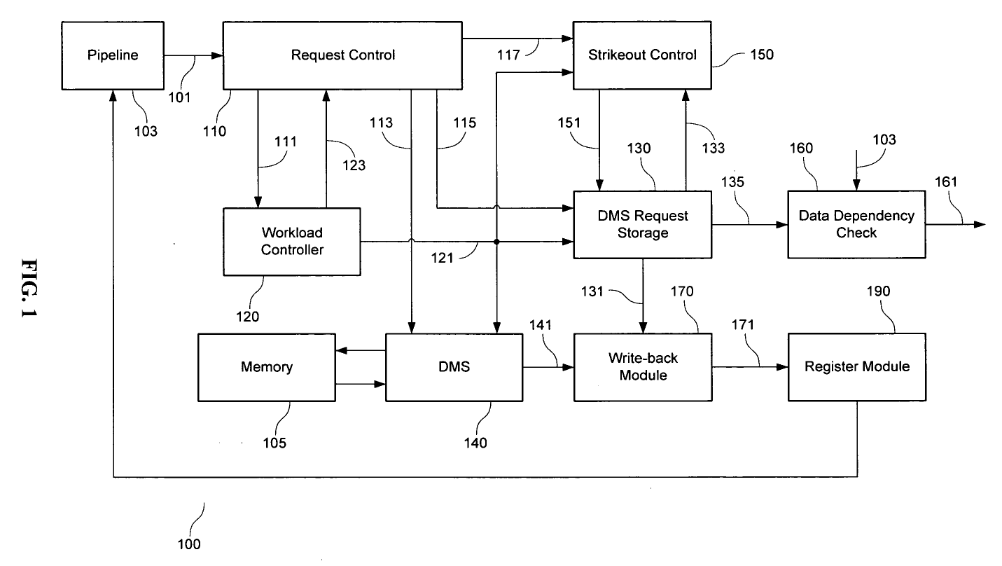

FIG. 1 shows a block diagram of an embodiment of the disclosure. A memory management module or a request control module 110 can receive memory retrieval requests or load requests 101 from a processing pipeline 103. The requests 101 can be requests to load memory contents from a predetermined origination location (memory location) to a destination location such as to a register in register module 190. The request control module 110 can be responsible to handle, to forward, and to manage the requests including controlling retrieval requests based on a number of pending requests or controlling the input of the system 100 based on an existing workload. The pipeline 103 can create an instruction that is a memory retrieval request, for example “R1=LOAD #80”, which can request to load register R1 in register module 190 with data from address 80 from memory 105.

When a load request is received from a multiprocessor pipeline 103 the control module 110 can process the request with the assistance of a memory retrieval request workload controller 120. Workload controller 120 can monitor the number of retrieval requests “in process” based on activities of control module 110 and other modules (i.e. a number of pending requests) and can prevent, at least partially, the execution of a retrieval request by the control module 110 (and other modules) in response to the plurality of pending retrieval requests being greater than a predetermine number such as a parameter, referred to herein as a memory limit request parameter.

In one embodiment, the retrieval request/workload controller 120 or workload controller of the memory retrieval system 100 can be an up down counter where the count is incremented when a request is accepted and processing is commenced by the control module 110. Conversely, the count can be decremented when a request has been completed at least partially, or a particular function at a particular stage of the system has processed the request. In another embodiment, the workload of the memory retrieval system can be controlled by the workload controller 120 utilizing a ticket or tag system.

In the tag system illustrated, the control module can request a tag from the workload controller 120 using a signal 111. The tag can be from a pool of tags where the pool contains defines a finite number. The pool can also have tags with different levels, weightings or ratings that are based on a difficulty (i.e. long lead times) or an average processing power/lead times and short lead times. Different memory devices can be assigned to different classes based on the number of cycles that a certain type of request typically takes to provide retrieval from the specific type of memory. For example, a tag can have a heavier weight if the contents have to be retrieved from an external hard drive and the tag can be lighter when the contents are to be retrieved from local cache. Also, the number of tags in the pool could be modified/user selected under specific conditions to improve performance.

The tag 121 sent to the DMS request storage module 130 can be associated with the request instruction and the request can be forwarded to the modules 130, 140, and 150 for processing. If the workload controller 120 cannot provide a tag or a tag with the proper weighting (in case, e.g., to many load request are pending) it can send a signal 123 which can cause the control module 110 to stall until at least one tag or a proper tag is available. Thus, control module can act as a gate keeper and “throttle” or act as a “governor” to the system 100.

The DMS request storage module 130 can receive the request 113 and the tag 121 associated with it and can store the request 113 with the tag 121. In parallel or concurrently, the request control module 110 can forward the request 113 with the associated tag 121 to a data memory subsystem (DMS) module 140. The DMS module 140 can fetch and load data from the memory 105 to the write back module 170 and/or a register in register module 190 according to the request/instruction. The register module 190 can be proximate to the processors of the pipeline 103 such that the data in a register is “immediately”/quickly available to the pipeline when needed. Generally, once the system 100 loads the requested data into one or more registers its task is complete.

In one embodiment, the request including particular additional information to support processing the request 117 such as a unique identifier and the associated tag 121 can be forwarded to the strikeout control module 150. The strikeout control module 150 can validate that the contents of the request are still needed (i.e. are not stale or obsolete). This can be accomplished in many ways without parting from the scope of the present disclosure. For example, an identifier can be assigned to the retrieval request and a tag indicating if the request is obsolete can be retrieval request.

An instruction that is flowing through the pipeline may have a condition and when the condition is affirmative the pipeline will need a first segment of data loaded into a register and when the condition is negative the pipeline will need a second/different data loaded into the register. Also, the system may just overwrite existing data when a condition is executed. Accordingly, the system will fetch data that may or may not be needed such that the processors are “covered” in most situations. When it is determined that retrieved data is not needed, the data can be purged or struck. Fetching of data that may or may not be needed by the pipeline allow the pipeline to run more efficiently. In traditional systems, the system would determined that it needs the data after the condition is executed and then all processors stall as the data is fetched where the processors may idle for many, many clock cycles.

In accordance with the present disclosure, the pipeline can generally avoid stalling or idling because when an instruction is processed by the processing pipeline that makes the retrieval request obsolete, strikeout control module 150 can tag the request as obsolete. Thus, the system 100 can be designed with such a bandwidth that it can retrieve and load twice as much data as needed by the processing pipelined. Accordingly, the system can place an identifier in a request, retrieve data “just in case” the pipeline may need it and can tag unneeded data as obsolete, and strike or purge this utilizing the identifier for tracking purposes. Generally, striking or purging the data can be understood as forgoing loading of the retrieval result (i.e. retrieved data) into the pipeline in response to determining that the retrieval request is obsolete.

As described above, system 100 can anticipate that an instruction will require one of first contents from a first memory location or second contents from a second memory location. The system 100 can retrieve the first content and the second content and the instruction can be executed by the pipeline 103. The system 100 can monitor the instruction to determine results of executing the instruction and the system can tag one of the first content or the second content as obsolete in response to the monitoring and purge the obsolete request.

In one embodiment, the processing pipeline can provide a status flag such as a validity flag 151 or associate a validity flag with the request regardless of what stage of processing the retrieval request is in. Thus, the system 100 can operate autonomously as the request is tagged and the result of the request can be “not” loaded into the pipeline many clock cycles after it is tagged or many cycles after it is determined that the results of the request are not needed or are obsolete. Thus, although tagged, the system may continue processing the request and the request can remain in the system and be ignored late in the process such as when it is time to load the register or when it is time to load the pipeline 103.

In another embodiment, when the data 141 and the tag associated with the request is returned by the DMS module 140 some cycles later the write-back module 170 can determine using data from the DMS module 140 whether the load request is still needed/valid. The write-back module 170 can also manipulate the sequence of the retrieved data received from the DMS module 140 according to register operation information. Register operation information can be associated with the request stored in the module 130.

For example, information about the data alignment, unneeded bit segments or data access can be utilized to manipulate or align bit segments of the data. For example, if the system operates as a thirty two (32) bit (four byte) system possibly only one byte is needed in a particular register for a particular execution and the retrieved data can be manipulated utilizing the information such that the appropriate register gets the appropriate byte of data. Many different manipulations are possible. For example, a lowest byte of the 32 bits of data can be sent to a particular register and data at odd byte addresses can be exchanged with data at even byte address to cope big-endian or little-endian access.

The manipulated data can be loaded into a register (R1, 2, 3 etc) of the register module 190 according to the load request. In parallel with, or concurrently with processing the load request, which can be stored in the DMS module 140, the request can be obsoleted/invalidated based on a conditional execution of the processor pipeline or other phenomena requiring the contents of a register to change. Also, contents of a loaded register can be invalidated and overwritten, thus, contents can be purged from the register or contents of a register can be overwritten. When this occurs, the workload controller 120 can detect that the system is “off loaded” and the tag associated with a request that is no longer needed can be returned to the workload/tag controller 120.

As stated above, each load request 101 received by the request control module 110 can be executed in parallel with executions of instructions in the multiprocessor pipeline. Also as stated above when a new request is received a tag can be taken from a pool of tags under control of the workload controller 120. Once data is returned from a DMS module 140 the tag can be added back into to the pool to be used in a subsequent request. It can be appreciated that the workload controller 120 can use a stack or any other logic and modules to manage at least one pool of available and reserved tags.

In another embodiment, the strikeout control module 150 can be informed when a register is loaded with contents. The register could loaded with data, for example register 1 with the value of 1 (e.g., R1=3), values can be shifter or moved between registers (e.g., R1=R2), the registers can be loaded with a result of an operation (e.g., R1=R2+R3) or registers can loaded from memory (e.g., R1=LOAD #90).

The strikeout control module 150 can determine via a signal from the DMS request storage module 130 whether a previous load request is pending for a specific register. The strikeout control module 150 can also receive information from processors 103 in the multiprocessor pipeline configuration indicating that a retrieval request has gone stale or obsolete where the results of the request are no longer needed and the strikeout module 150 can tag the request as obsolete. Thus, the strikeout control module 150 can determine if there is a pending load request, can determine if the request is obsolete and can set or reset a obsolete/validity flag in the DMS request storage module 130 to indicate that a pending load request is obsolete (not needed) or not obsolete (still needed).

The DMS request storage module 150 can operate autonomously where, even though this flag is set, the DMS storage module 150 can operate unaffected by such setting of the obsolete flag. The flag can be read, checked, or utilized when it is time to load a register or the pipeline and the some retrieved contents that are flagged as obsolete can be prohibited from loading at this time/location. So the DMS storage module 150 may continue execution to completion the processing of a request that was flagged or tagged as obsolete many clock cycles ago.

Once the DMS module 140 executes the retrieval request and returns the contents/data such that they are available to load in a register, the write-back module 170 (a gate keeper) can determine based on the setting of the obsolete status/validity flag that has been stored in the DMS request storage module 140 that the system can forgo loading the retrieved contents (or not write the retrieved contents) to the destination register. Essentially, the request can be cancel by not loading the results of the request into a next stage or storage or execution subsystem.

In one embodiment, data dependency check module 160 can determine when an instruction used by a processor in the multiprocessor pipeline needs data from a register. The data dependency check module 160 can identify the memory contents stored in, or being processed by, the DMS request storage module 130 and can determine whether a register to be accessed by a processor executing an instruction has a pending load request or whether the register has been loaded with the required contents. When the data dependency check module 160 finds that a pending load request is not complete, or the retrieval contents are not available, the data dependency check module 160 can send a signal 161 to the pipeline 103 causing the pipeline 103 to stall until the request has been processed and the data requested is available in the appropriate register.

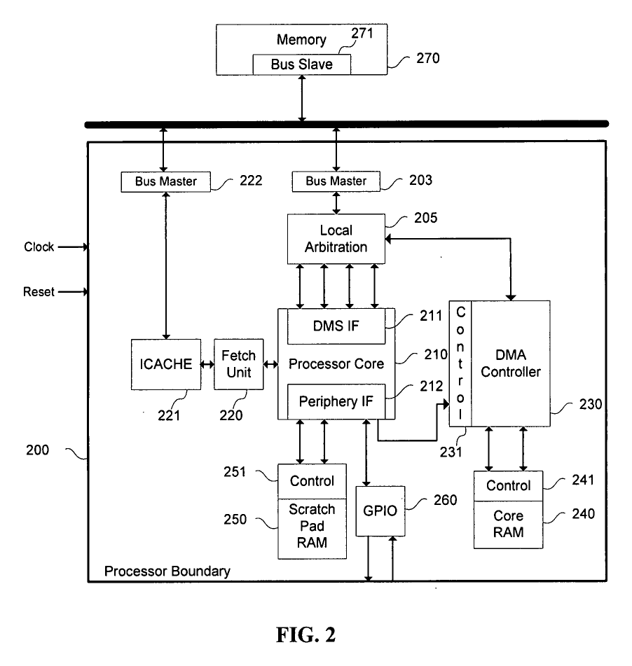

FIG. 2 shows a block diagram overview of a processor 200 which could be utilized to process image data, video data or perform signal processing, and control tasks. The processor 200 can include a processor core 210 which is responsible for computation and executing instructions loaded by a fetch unit 220 which performs a fetch stage. The fetch unit 220 can read instructions from a memory unit such as an instruction cache memory 221 which can acquire and cache instructions from an external memory 270 over a bus or interconnect network.

The external memory 270 can utilize bus interface modules 222 and 271 to facilitate such an instruction fetch or instruction retrieval. In one embodiment the processor core 210 can utilize four separate ports to read data from a local arbitration module 205 whereas the local arbitration module 205 can schedule and access the external memory 270 using bus interface modules 203 and 271. In one embodiment, instructions and data are read over a bus or interconnect network from the same memory 270 but this is not a limiting feature, instead any bus/memory configuration could be utilized such as a “Harvard” architecture for data and instruction access.

The processor core 210 could also have a periphery bus which can be used to access and control a direct memory access (DMA) controller 230 using the control interface 231, a fast scratch pad memory over a control interface 251, and to communicate with external modules, a general purpose input/output (GPIO) interface 260. The DMA controller 230 can access the local arbitration module 205 and read and write data to and from the external memory 270. Moreover, the processor core 210 can access a fast Core RAM 240 to allow faster access to data. The scratch pad memory 250 can be a high speed memory that can be used to store intermediate results or data which is frequently utilized. The fetch and decode method and apparatus according to the disclosure can be implemented in the processor core 210.

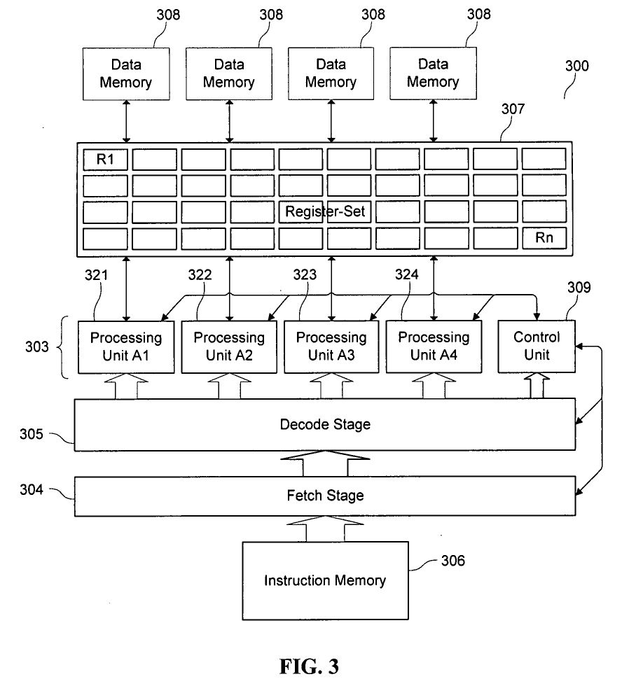

FIG. 3 shows a high-level overview of a processor core 300 which can be part of a processor having a multi-stage instruction processing pipeline. The processor 300 shown in FIG. 3 can be used as the processor core 210 shown in FIG. 2. The processing pipeline of the processor core 301 is indicated by a fetch stage 304 to retrieve data and instructions, a decode stage 305 to separate very long instruction words (VLIWs) into units, processable by a plurality parallel processing units 321, 322, 323, and 324 in the execute stage 303. Furthermore, an instruction memory 306, can store instructions and the fetch stage 304 can load instructions into the decode stage 305 from the instruction memory 306. The processor core 301 in FIG. 3 contains four parallel processing units 321, 322, 323, and 324. However, the processor core can have any number of parallel processing units which can be arranged in a similar way.

Further, data can be loaded from or written to data memories 308 from a register area or register module 307. Generally, data memories can provide data and can save the results of the arithmetic proceeding provided by the execute stage. The program flow to the parallel processing units 321-324 of the execute stage 303 can be influenced for every clock cycle with the use of at least one control unit 309. The architecture shown provides connections between the control unit 309, processing units, and all of the stages 303, 304 and 305.

The control unit 309 can be implemented as a combinational logic circuit. It can receive instructions from the fetch 304 or the decode stage 305 (or any other stage) for the purpose of coupling processing units for specific types of instructions or instruction words for example for a conditional instruction. In addition, the control unit 309 can receive signals from an arbitrary number of individual or coupled parallel processing units 321-324, which can signal whether conditions are contained in the loaded instructions.

Typical instruction processing pipelines known in the art have a fetch stage 332 and a decode stage 334 as shown in FIG. 1. The parallel processing architecture of FIG. 3 which is an embodiment of the present disclosure has a fetch stage 304 which loads instructions and immediate values (data values which are passed along with the instructions within the instruction stream) from an instruction memory system 306 and forwards the instructions and immediate values to a decode stage 305. The decode stage expands and splits the instructions and passes them to the parallel processing units.

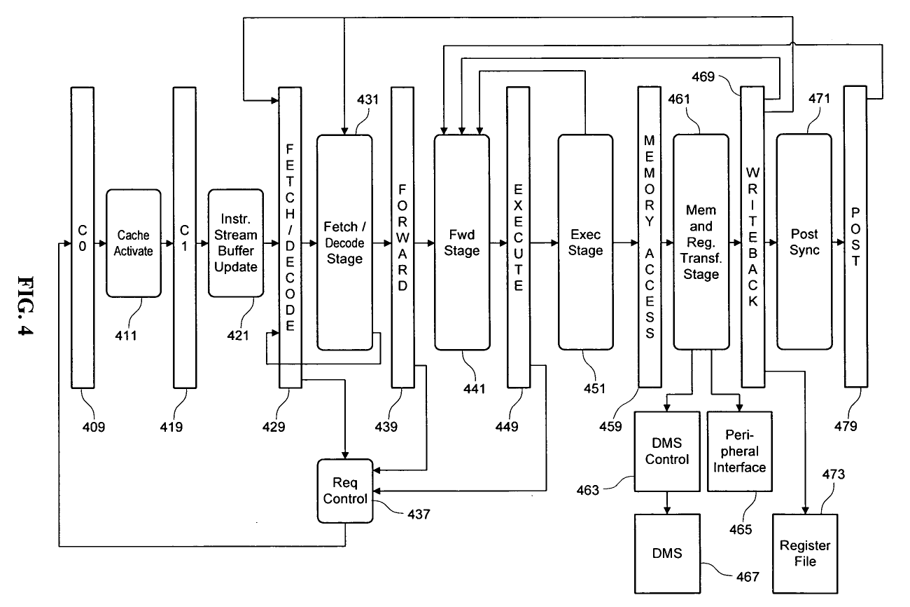

FIG. 4 shows in another embodiment of the present disclosure a pipeline in more detail which can be implemented in the processor core 210 of FIG. 2. The vertical bars 409, 419, 429, 439, 449, 459, 469, and 479 can denote pipeline registers. The modules 411, 421, 431, 441, 451, 461, and 471 can read data from a previous pipeline register and may store a result in the next pipeline register. Modules with a pipeline register forms a pipeline stage. Other modules may send signals to no, one, or several pipeline stages which can be the same, one of the previous, one of the next pipeline stages.

The pipeline shown in FIG. 4 can consist of two coupled pipelines. One pipeline can be an instruction processing pipeline which can process the stages between the bars 429 and 479. Another pipeline which is tightly coupled to the instruction processing pipeline can be the instruction cache pipeline which can process the steps between the bars 409 and 429.

The instruction processing pipeline can consist of several stages which can be a fetch-decode stage 431, a forward stage 441, an execute stage 451, a memory and register transfer stage 461, and a post-sync stage 471. The fetch-decode stage 431 can contain of a fetch stage and a decode stage. The fetch-decode stage 431 can fetch instructions and instruction data, can decode the instructions, and can write the fetched instruction data and the decoded instructions to the forward register 439. Within this disclosure an instruction data is a value which is included in the instruction stream and passed into the instruction pipeline along with the instruction stream. The forward stage 441 can prepare the input for the execute stage 451. The execute stage 451 can consist of a multitude of parallel processing units as explained with the processing units 321, 322, 323, or 324 of the execute stage 303 in FIG. 3. In one embodiment of the disclosure the processing units can access the same register as explained with regard to register file 307 in FIG. 3. In another embodiment, each processing unit can access a dedicated register module.

One instruction to a processing unit of the execute stage can be to load a register with instruction data provided with the instruction. However, the data can need several clock cycles to propagate from the execute stage which has executed the load instruction to the register. In conventional pipeline design without a so-called forward functionality, the pipeline may have to stall until the data is loaded to the register to be able to request the register data in a next instruction. Other conventional pipeline designs do not stall in this case but disallow the programmer to query the same register in one or a few next cycles in the instruction sequence.

However, in one embodiment of the disclosure a forward stage 441 can provide data which will be loaded to registers in one of the next cycles to instructions that are processed by the execute stage and need the data. In parallel, the data can propagate through the pipeline and/or additional modules towards the registers.

In one embodiment, the memory and register transfer stage 461 can be responsible to transfer data from memories to registers or from registers to memories. The stage 461 can control the access to one or even a multitude of memories which can be a core memory or an external memory. The stage 461 can communicate with external periphery through a peripheral interface 465 and can access external memories through a data memory sub-system (DMS) 467. The DMS control module 463 can be used to load data from a memory to a register whereas the memory is accessed by the DMS 467.

A pipeline can process a sequence of instructions in one clock cycle. However, each instruction processed in a pipeline can take several clock cycles to pass all stages. Hence, it can happen, that data is loaded to a register in the same clock cycle when an instruction in the execute stage requests the data. Therefore, embodiments of the disclosure can have a post sync stage 471 which has a post sync register 479 to hold data in the pipeline. The data can be directed from there to the execute stage 451 by the forward stage 441 while it is loaded in parallel to the register file 473 as described above.

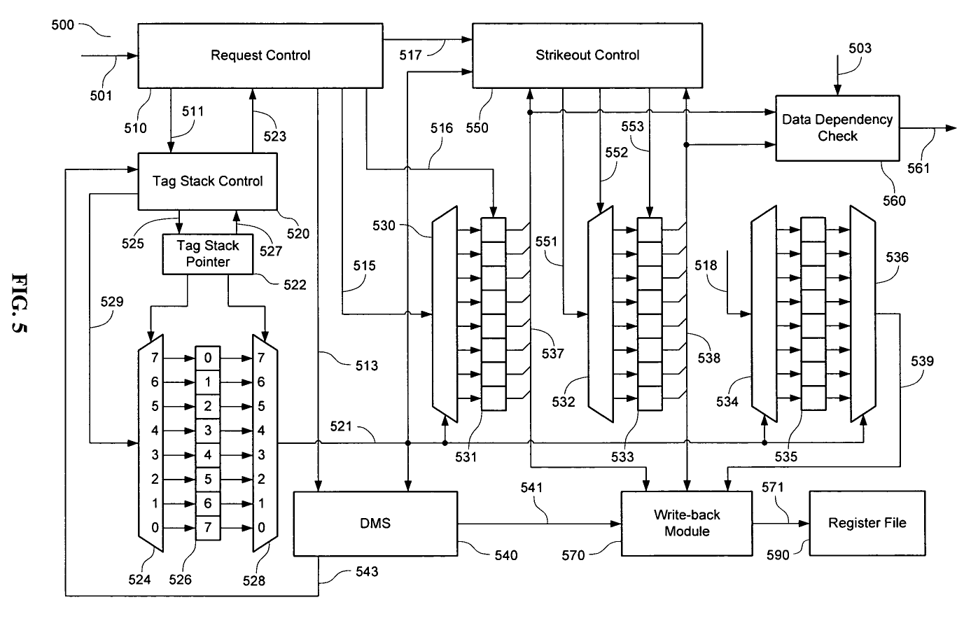

Referring to FIG. 5, an exemplary embodiment of a memory control system 500 is disclosed. FIG. 5 is similar to FIG. 1 however the DMS request storage module 130 of FIG. 1 is drawn in more detail. Thus, the system 500 can include a request controller 510, a strikeout controller 550, a data dependency checker 560 a tag control 520, tag pointer 522, a DMS 540 a write back module 570 and registers 590.

In the illustrated embodiment, DMS control module generally includes components 524 526 528 530 531 532 533 534 535 and 536. The DMS control module 540 can handle load requests to load register 590 with data from a memory (not shown). A simple retrieval request or instruction which could create a retrieval and load request could be, for example: R1=LOAD #80. Generally, these sample instruction request a load into register R1 of data/contents located at memory address 80. Thus, the retrieval request can have a source identifier (the location in memory where the requested contents are stored) and a destination identifier “R1” the register where the contents are to be placed.

Referring briefly to FIG. 10, a small segment of code or a “snippet” of code for a memory retrieval system is provided for illustrative purposes. As illustrated numerous lines of code between 1002 and 1003 are omitted for simplification. It can be appreciated that traditional or conventional processor architectures make a memory request and then stall once the load request in line 1001 is issued. Thus, the processors in the pipeline can remain stalled until the requested data is loaded into the register R1. Such a retrieval and loading process may take tens of clock cycles depending on where the data is located and how fast the memory that has the stored request can operate. Thus, in a conventional system the retrieval process can take a relatively long time and during such time the processors of the pipeline are not executing instructions and providing results. It can be appreciated that this creates considerable inefficiencies and limits the processing power of these traditional systems. In such traditional systems once the data is retrieved and loaded into registers then the processor(s) can restart or continue where they left off, here at the next instruction shown in line 1002.

Referring back to FIG. 5 and in accordance with the present disclosure, the memory system 500 can anticipate what data might be needed by the processing pipeline and in parallel or concurrently with the processors executing instructions, the memory system 500 can retrieve and load “excess” data or all data that has a possibility of being needed to complete execution of a particular instruction such that the stalling and idle time associated with traditional systems is greatly reduced and often avoided. Anticipating data that may be required and discarding the data when it is not needed, can significantly increase the processing efficiency of a pipeline system when compared to traditional “request and wait” systems. Accordingly, can pipeline be fed with a sequence of instructions that can be processed continuously and “all” data that might be needed can be fetched in parallel such that is infrequent that the system has to stall or wait for a load request to be completed.

The requirement for specific contents/data can be anticipated such that prior to the time that the pipeline processors need the data, the memory system can in parallel retrieve the data that it believes will be needed and thus, execution of instructions can continue uninterrupted. As will be discussed below, although infrequent, there may be occasions where critical data is not available (possibly long lead time data, a misread condition or other failure) where the pipeline must be stalled. In one embodiment, a load request can contain additional load requests and as stated above the memory system 500 can execute multiple requests concurrently.

The memory system 500 can detect when a condition is going to be executed by the processor. In such as case the processor may need contents from a first location such as from address 40 or from a second location such as address 80. In anticipation of the condition, the processor or the system 500 can request the contents of both locations, then after executing the condition, the processor can tag the results of the request that is not needed as obsolete and load the desired or not obsolete request into the pipeline.

In one embodiment, the request control module 510 can receive a load request 501 from the pipeline. The load request can have the following information: the address of the data in the memory to be read, the destination register to be loaded, and the bits or bytes of the destination register which are loaded. A load request 501 can correspond to a load instruction from a memory as described above, e.g., R1=LOAD #80. When the request control 510 receives a load request 501 it can request a tag from a tag stack control module 520. The tag stack control module 520 can control a tag stack pointer 522 using signals 525. The tag stack pointer 525 can mark a next free tag in a tag stack 526. In an initial state, the tag stack pointer 522 can have an initial value of 0 and count up as tags are taken from the pool of tags to a memory request limit number or parameter which is a predetermined effective working capacity of the memory system 500.

The tag stack 526 can store a set of unique tag numbers that limits the amount of tags that are checked out of the pool. When a tag is requested, the next free tag can be output as a current tag 521 and the tag stack pointer can be increased. The current tag 521 can be used to switch the selection logics 530, 534, and 536 and the tags can be forwarded to the strikeout control module 550. When a memory retrieval request is made and no more tags are available in the tag stack 526, the tag stack control module 520 can send a stall signal 523 back to the request control module 510 to force the pipeline to stall until at least one free tag is available in the tag stack thereby limiting the workload of the system 500 ensuring that the system operates at an acceptable speed for retrieval of memory contents.

When tags 543 are returned to the tag stack control module 520 (this case will be discussed below) the tag stack control module 520 can decrement the tag stack pointer 522 appropriately and can store the freed/returned tags 543 back to the tag stack 526 using signals 529. When the request control 510 receives a load request 501 it can try to retrieve a current tag 521 from the tag stack control module 520 as discussed above. The current tag 521 then can be tied to the load request 513 and can be forwarded to a data memory subsystem (DMS) 540 which can perform the read/retrival from the memory.

The request control 510 can use the current tag 521 to provide relevant information about the load request. Relevant information can include the destination register 515 of the data to be read from memory which can be stored in a destination register number array 531 and additional information 518, e.g., a byte address can be stored in a register operation array 535. A byte address can in some embodiments be utilized to load just a few bytes of the 4 or eight bytes of retrieved data to the register (i.e., the load request 513 forwarded to the DMS can trigger a read of a 32 bit word from memory whereas, only the lower two bytes are loaded to the register).

When the request control 510 stores the information 515 and 518 in arrays 531 and 535, the current tag 521 and the load request 517 in parallel can also be forwarded to a strikeout control module 550. The strikeout control module 550 can be responsible to validate and invalidate a load request stored in the arrays 531 and 535. When a load request 517 is received by the strikeout control module 550 the load request is validated and a corresponding validity bit 551 can be set in the load request validity array 533 using a tag 552.

Referring again briefly to FIG. 10, line 1001 when the load request R1=LOAD #80 is received as a signal 501 by the control module 510, the control module 510 can request a new tag from the tag stack control module 520. In the example referred to above, assume that a current tag 521 has a value of three. The control module 510 can use the current tag 521 and associate the number of the register (i.e. register three R3) in the destination register number array 531. The control module 510 can also store information that a 32-bit data transfer is initiated in the register operation array 535 at position three.

However, in parallel, the load request R1=LOAD #80 can be associated with the current tag 521 and can be forwarded with the tag 521 to the DMS 540 by the control module 510 using a signal 513 and the DMS 540 can perform the memory retrieval process. Moreover, in parallel, the control module 510 can also forward the load request to the strikeout module 550 using a signal 517. The strikeout module 550 can also receive the current tag 521. The strikeout module 550 can then set a validity bit in a load request validity array 533 to mark the load request as a valid new request.

The example instruction R1=LOAD #80 of line 1001 in FIG. 10 was used to demonstrate how a load request is initiated and based on the request how tagged memory contents can be placed in registers of the pipeline. The DMS module 540 can perform the read task as initiated by the control module 510 with the tag associated with the load request. It is to note, that the control module 510 can cause the pipeline to stall when a request is made and no more tags are available in the tag stack. The control module 510 can keep the pipeline stalled until at least one tag is available and then accept or process another request. In other embodiments, the control module 510 may send a signal to the pipeline that a load request has failed for some reason (i.e. the required data is not loaded). The destination register number arrays 531 can store information about all registered and pending load requests and the DMS module 540 can handle load requests received in arbitrary order.

Once the DMS module 540 has successfully completed loading data from the memory it can send the data with the tag associated with the load request which has issued the load to a write-back module 570. The write-back module 570 can use the tag to check in the load request valid array 533 with a signal 538 whether the request is still valid which will be discussed below. If the request is still valid the destination register number stored for the tag can be loaded from the destination register number array 531. The write-back module 570 can use the destination register number to write the data read by the DMS module 540 to the corresponding register in the register module 590. Embodiments of the disclosure can use information stored for the tag in a register operation array 535 to align the data read by the DMS module 540 before the data is written to the destination register in the register file 590 or can load only a certain bit-range or certain bytes segments contained in the destination register. Moreover, as the load request has been successfully completed, the DMS module 540 can return the tag 543 of the completed load request to the tag stack 526. Therefore, the tag stack pointer 522 can be decremented by the tag stack control module 520 and the free tag 529 can be written to the tag stack.

For example, when the load request R1=LOAD #80 of line 1001 in FIG. 10 has successfully completed by the DMS module 540, the DMS module 540 can send the data with the tag associated with the load request to the write-back module 570 which can use the tag, e.g. 3, to check whether the request is still valid. If the request is valid the write-back module 570 can read the destination register number from the destination register number array 531 (which can be, e.g., 1 for the register R1). The write-back module 570 can also read the information stored in the register definition operation array 531 to assist in controlling the data transfer to the destination register. After at least a portion of the load task has been completed the tag number “three” can be returned to the tag stack, i.e., the tag stack pointer 522 can be decremented and “tag three” can be stored on the tag stack.

As describe above, the system 500 can create, register, track, monitor, manage, and complete asynchronous memory retrieval and load requests. As described above instructions processed by the pipeline can affect the handling of load requests and the system 500 can affect the execution of instructions in the pipeline. Pending load requests can cause dependent instructions to wait and hence can affect the execution of instructions. Moreover, the disclosed tag stack control arrangement can cause the pipeline to stall when the tag stack runs out of tags and temporarily no additional load requests will be handled. The size of the tag stack or number of tags in the pool can be a predetermined number and a design parameter of the architecture of the DMS module 543 which, although adjustable, optimization of such a parameter is not within the scope of the present disclosure.

The data dependency check module 560 can handle processing of instructions which need data of registers for which a load request 501 has been issued but which have not been yet completed. The data dependency module 560 can receive information 503 about instructions which are processed in a certain pipeline stage, e.g., the forward stage and/or the execute stage and can monitor, if an instruction that is, e.g., executed in the execute stage needs data from a register, for which a load request has been issued without completing the load task. This can be the case, if a register is used soon after a load request has been raised and when the load procedure needs several cycles to complete, e.g., for DMA memory accesses. The processor pipeline may have to stall until the load has been completed. Therefore, the data dependency check module 560 can monitor the instructions which are processed in the pipeline or registers necessary to execute the instructions and on the other hand can monitor the load requests which have been registered but not completed, e.g., by means of the signals 537, and 538. When the data dependency check module 560 detects an instruction that uses a register for which a load request is still pending, it can raise a stall signal 561 and can cause the pipeline to stall until the data for the requested register is available.

Again referring to FIG. 10 line 1001 is a load request to retrieve data from address 80 and place a copy of the data into register R1. Line 1003 shows an instruction which needs the data of register R1 to calculate the value of R4. The dependency of the register R1 is denoted by an arrow. The data dependency check module 560 can detect that the registers R1 and R5 are needed for the execution of this instruction. However, if the load request of line 1001 is not completed, the data dependency check module 560 can find an entry in the destination register number array 531 for the register R1. The module 560 can check in the load request validity array 533 whether the load request for the register is still valid. If it is valid, the data dependency check module 560 can raise a signal 561 causing the pipeline to stall until the load request is completed and data has been loaded to R1.

The strikeout control module 550 can be the master of the load request validity array 533. The strikeout control module can receive load requests 517 assigned to a tag 521 from the request control module 510. When a load request is received the strikeout control module can set a validity flag for the request in the load request validity array telling that the request is valid and that the loaded data has to be stored in the destination register. Depending on the performance of the DMS module 540 and the memories which are accessed by the DMS module the load request can take several clock cycles, i.e., as explained above, the destination registers can be loaded asynchronously by the DMS control module 500 while the pipeline can continue execution in parallel. In some cases a register for which a load request has been raised is loaded with data for an instruction, subsequent to the instruction raising the load request. Additionally, an instruction stream can request a load from two different memory locations to a single or the same register. As stated above a conditional execution, can request that a register is loaded in case where a condition is true overwriting a previous loaded data (which would be utilized if the condition was false). However, load requests can be handled concurrently as the DMS 540 may handle one request faster than another.

Therefore, subsequent loading or conditional loading of registers can be handled by the strikeout control module 550. The strikeout control module 550 can be informed when a register is loaded, with the appropriate data including when a register is loaded with data from another register. On one embodiment the strikeout control module 550 can search for the register using the register number associated with the data, possibly consulting the destination register number array 531. If the strikeout control module 550 finds an entry (data) for the register that is not needed or is obsolete, the strikeout control module 550 can reset the validity flag for that entry, indicating that the data of the subject request may not be loaded to a destination register.

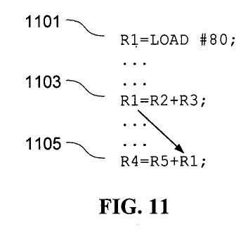

An example for such a situation is given by the code segment of FIG. 11. In line 1101 a load request is issued whereas the system has requested that register R1 be loaded with data from memory address 80. In line 1103 the register R1 can be overwritten with the sum of R2 and R3. Even though R1 is to be over written the load request of line 1101 can still be pending or can still be in process. The strikeout control module 550 can find the request in the array 531 and can reset the validity flag for this request making it an obsolete request. When in a subsequent clock cycle the DMS module 540 returns the data of the load request and the tag associated with the request, the write-back module 570 can determine that the request should not be written to the register file 590 an can flag the request to be cancelled.

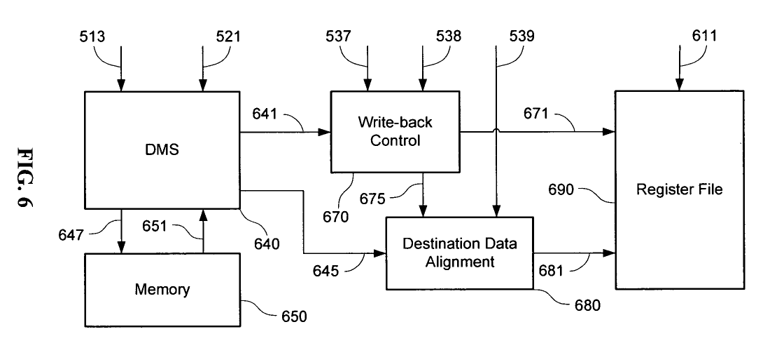

FIG. 6 is a block diagram of a write-back module consisting of a write-back control module 670 and a destination data alignment module 680 which can receive data 645 returned by a DMS module 640 and a tag 641 associated with the load request. The load request can request data from memory to be stored in a register file 611. The DMS module 640 can receive a load request 513 and a tag associated with the request and can load the requested data from a memory 650. The DMS module 640 in some embodiments can have access to different types of memories or memories within the processor or outside of the processor and can also handle a multitude of parallel load requests. When the data is loaded the DMS module 640 can forward the data 645 to a destination data alignment module 680 and/or can forward the tag 641 associated with the load request to the write-back control module 670.

The write-back control module 670 can receive validity information 538 and can check if the validity flag for the tag 641 is still set. If the flag is not set, the load request can be canceled. The write-back control module 670 can retrieve register number information 537 and can determine which destination register was assigned with the load request of the tag 641 and can send destination register access control information 671 to the register file 690.

The destination data alignment module 680 can retrieve the data 645 and information 539 about the data alignment or data access and can manipulate the order of the retrieved data or reformat the data, strike portions of the retrieved data and/or align the data 645 according to information 539 associated with the retrieval. The destination data alignment module 680 can also send the reformatted/manipulated data to the register file 690. For example, if only the lowest byte has to be loaded into a register when a standard retrieve/load request of 32 bits is made the 32 bits can be sent to the DMS control data alignment module 680 where only the lowest byte of the data can be forwarded to the register file 690. Such a process is only one reformatting procedure that the alignment module 690 may perform. In another case, the alignment information can contain information to exchange the bytes of an odd byte address with bytes at an even byte address to allow “big-endian” or “little-endian” type access. Hence, the alignment module 690 can send reformatted data and access information regarding which register of the register module should be loaded 690.

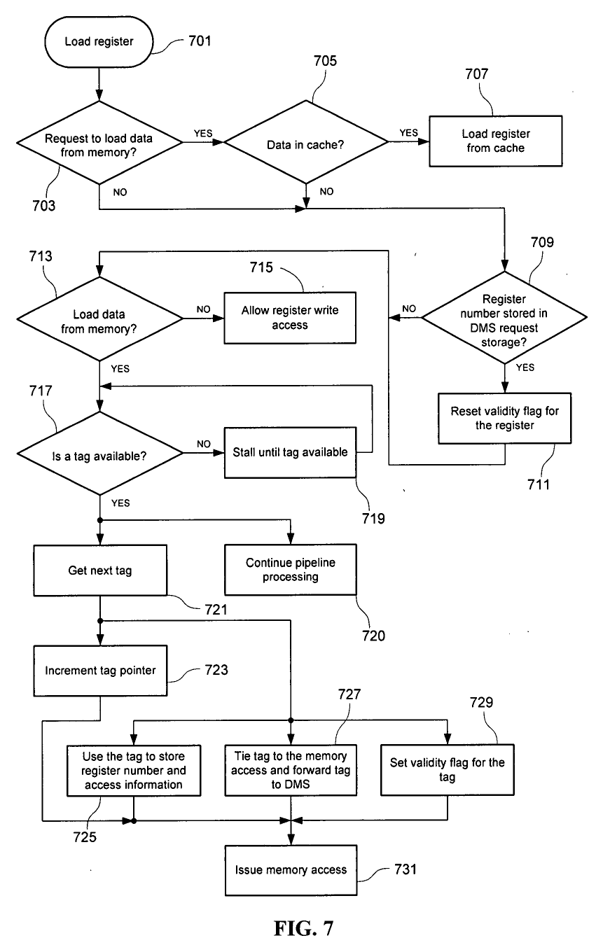

FIG. 7 is a flow diagram of a method for issuing asynchronous memory load requests. As illustrated by block 701 the method can be triggered when a register load request to a DMS control module is issued. At decision block 703, it can be determined if data from a memory is requested. When data is requested from a memory location, it can be determined at decision block 705 whether the data is in the cache or not. If the data is in the cache the data can be loaded from the cache as illustrated by block 707.

At decision block 709, it can be determined whether the register number is stored in the DMS request storage. If the register number is found, the validity flag for the register can be reset as illustrated by block 711. At decision block 713 it can be determined whether data is to be loaded from a memory. In case data is not loaded from a memory, the write access to the register can be allowed, where a load of memory contents in to a register can be performed as indicated by block 715. At decision block 717 it can be determined whether a tag is available from a tag stack. If no tag is available, the memory system and the pipeline can stall until at least one tag is available as illustrated by block 719.

However, if a tag is available the pipeline can continue processing the instruction stream as indicated by block 720. In parallel, a tag can be retrieved from the stack, as illustrated by block 721 and the tag stack pointer can be incremented as illustrated by block 723. As illustrated by block 725 the tag can be utilized to store the register number and the access information. The register number can be used subsequently to determine which register will be fed the data.

As illustrated by block 727, the load request can be tied to the tag and forwarded to the DMS module which can perform the memory access. Moreover, the validity flag can be set for the memory request to indicate that the data has to be loaded to the register when received from the DMS module, as illustrated by block 729. The instructions of blocks 725, 727, and 729 can be processed in parallel to block 723 as shown in FIG. 7 or sequentially. The load request can be executed by a DMS module which can access the memory and can transfer the data from the memory to the processor as illustrated by block 731.

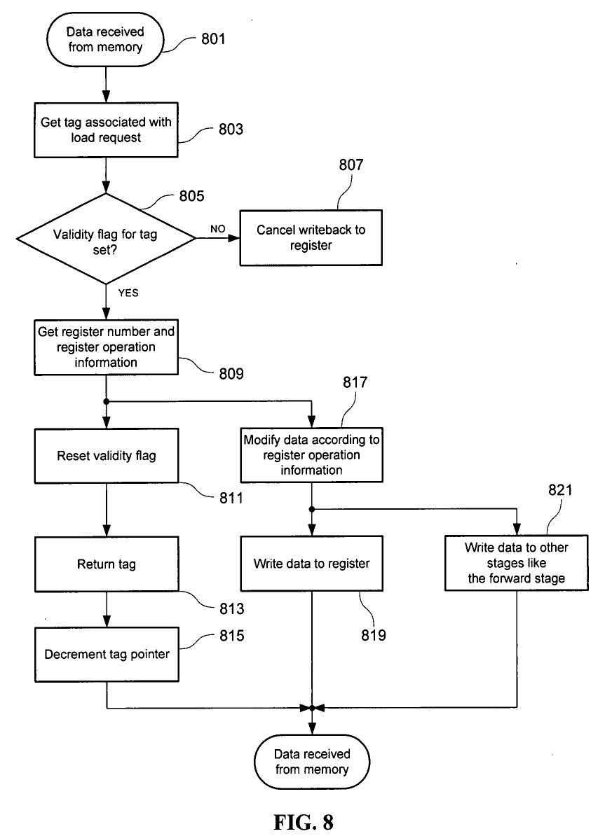

FIG. 8 is a flow diagram of a method for asynchronously reading data from a memory and loading the data. As illustrated by block 801, the method can be triggered when the requested data is retrieved. The tag which is associated with the load request and the data can be retrieved from a DMS as illustrated by block 803. At decision block 805 it can be determined whether a validity flag is set for the tag. If the validity flag is not set—e.g., it has been reset by a different function or logic to avoid or forgo writing the data to the register—the load task can be canceled and the contents of the destination register will not modified, as illustrated by block 807. As illustrated by block 809, the tag can be utilized to retrieve the destination register number and the register access information.

The destination register number and the register access information can be stored and retrieved from a DMS request storage module. As illustrated by block 811, the validity flag for the load request which can be stored in a DMS request storage module can be reset to indicate that the load task will be completed when the flow of FIG. 8 is completed. As illustrated by block 813 the tag associated with the load request can be returned to a tag stack and can be used again by a subsequent load request. The tag stack pointer can be decremented as illustrated by block 815 to prepare the tag control for a subsequent request.

As illustrated by block 817, once register operation information is available from block 808 the data, in some embodiments can be manipulated/rearranged/reformatted according to the register operation information. Such a modification can be, e.g., to swap odd and even bytes or to extract certain bytes or bits from the data which shall be loaded to the destination register. As illustrated by block 819, the so reformatted data can be written to the destination register. As illustrated by block 821 in parallel to writing to the destination register, the data can be forwarded to a certain pipeline stage such as the forward stage which can enable to use the data written to the destination register within the same cycle in the pipeline.

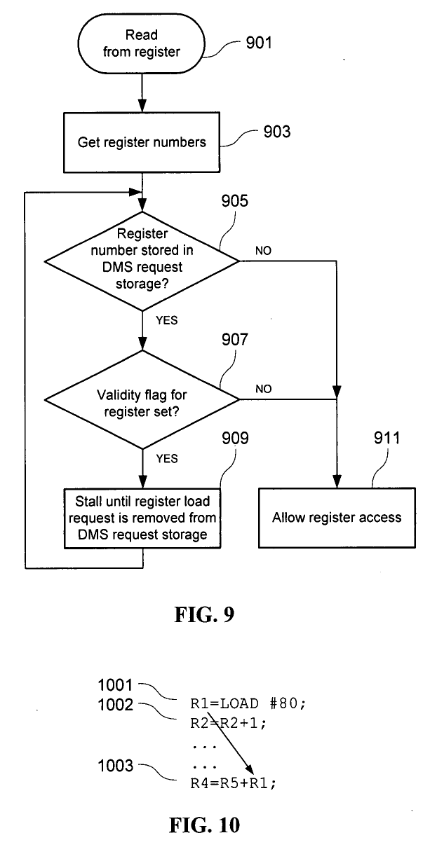

FIG. 9 is a flow diagram of a method for accessing data of a register for which an asynchronous memory load request has been issued. As illustrated by block 901, the method can be triggered when a register is read. As illustrated by block 903, the register number can be determined. The register number can be used to determine whether a load request for the register has been issued, as illustrated by block 905. The load requests can be stored and managed by a DMS request storage module. If a load request for the register is found it can be determined whether the validity flag for the register load request is set as illustrated by block 907. If the validity flag is set the processor pipeline can stall until the register number is removed from the DMS request storage, as illustrated by block 903. If the validity flag is not set, or no register load request could be found, the register read access can be allowed as illustrated by block 903.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can control a memory system. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method comprising:
storing a memory request limit parameter;
receiving a memory retrieval request from a multi-processor system to retrieve contents of a memory location and to place the contents in a predetermined location;
determining a number of pending memory retrieval requests; and
processing the retrieval request in response to comparing the determined number of pending memory retrieval requests with the memory request limit parameter.

2. The method of claim 1, wherein determining the number of pending memory retrieval requests comprises:
counting a number of requests sent to a memory management system to create a count; and
modifying the count if at least one of a memory retrieval requests sent to the memory management system has been processed by at least a portion of the memory management system.

3. The method of claim 1, wherein determining the number of pending requests comprises:
determining the number of requests accepted by a memory management system; and
determining if a request has become obsolete based on the processing of a subsequent instruction and modifying the number of pending requests if a memory retrieval request has become obsolete.

4. The method of claim 1, wherein processing of the retrieval request is performed if the pending number of retrieval requests is less than the memory request limit parameter.

5. The method of claim 1, further comprising not sending a retrieval request to the memory management system if the pending number of retrieval requests is greater than the memory request limit parameter.

6. The method of claim 1 further comprising storing the memory retrieval request in response to comparing the pending number of retrieval requests to the memory request limit parameter.

7. The method of claim 1, wherein determining comprises:
allocating a predetermined number of tags to create a pool of tags; and
assigning a tag to a memory retrieval request in response to a memory management system accepting the request.

8. The method of claim 7, further comprising:
receiving a response to the memory retrieval request;
placing the tag back in the pool in response to the received request; and
indicating that a tag is available.

9. The method of claim 7, wherein memory retrieval request are asynchronous.

10. The method of claim 7, further comprising processing an instruction that requests contents to be retrieved in accordance with a prior request and stalling a pipeline if the contents to be retrieved are not available.

11. An apparatus comprising:
a memory management module to retrieve data from a memory in response to a retrieval request from a multi-processor to perform as a processing pipeline, the memory management module to process a plurality of retrieval requests concurrently;
a memory retrieval request controller to monitor the plurality of retrieval requests in process within the memory management module and to prevent, at least partially, execution of a retrieval request by the memory management module in response to a parameter related to the plurality of retrieval requests being greater than a predetermine parameter.

12. The apparatus of claim 11, wherein the parameter is a number of pending requests

13. The apparatus of claim 12, further comprising a tag module to assign tags, from a pool of tags having a predetermined number of tags, to retrieval requests in process, wherein monitoring comprises determining when there are no tags available in the pool and the parameter related to the plurality of retrieval is a no tag left parameter.

13. The apparatus of claim 11, wherein if the tags from the pool are depleted, the memory retrieval request controller stores retrieval requests delaying sending the retrieval request to the memory management system until the pool is not depleted.

14. The apparatus of claim 11, wherein the requests are generated by a multi-processor system.

15. The apparatus of claim 11, wherein the requests are asynchronous to the processing in a processing pipeline and are generated by the processing pipeline, the processor utilizing very long instruction words.

16. A computer program product comprising a computer useable medium having a computer readable program, wherein the computer readable program when executed on a computer causes the computer to:
store a memory request limit;
receive a memory retrieval request from a multi-processor system to retrieve contents of a memory location;
determine a number of pending memory retrieval requests; and
process the retrieval request in response to comparing the determined number of pending memory retrieval requests with the memory request limit.

17. The computer program product of claim 16, further comprising a computer readable program when executed on a computer causes the computer to counting a number of requests sent to a memory management system to create a count;
subtracting from the count if at least one of a memory retrieval requests sent to the memory management system has been processed by at least a portion of the memory management system.

18. The computer program product of claim 16, further comprising a computer readable program when executed on a computer causes the computer to determine a number of requests accepted by a memory management system and to determine, if the memory management system has provided a response to the request.

19. The computer program product of claim 16, further comprising a computer readable program when executed on a computer causes the computer to process the retrieval request if the pending number of retrieval requests is less than the memory request limit.

20. The computer program product of claim 16, further comprising a computer readable program when executed on a computer causes the computer to assign tags, from a pool of tags, to retrieve requests in process, the pool having a predetermined number of tags wherein if the tags from the pool are depleted, the memory retrieval request controller stores retrieval requests delaying sending the retrieval request to the memory management system until the pool is not depleted.
